(19) United States
(12) Patent Application Publication
(10) Pub. No.: US 2011/0315794 A1
(43) Pub. Date: Dec. 29, 2011

(54) Hose Nozzle

(76) Inventor: Kevin Franklin Albrecht, Chino Hills, CA (US)

(21) Appl. No.: 12/822,163

(22) Filed: Jun. 23, 2010

(51) Int. Cl. B05B 15/00

(52) U.S. Cl. 239/547

(57) ABSTRACT

The present disclosure provides a hose nozzle having a rigid tube outer tube, a resilient inner tube member disposed within the rigid outer tube and configured to define a flow of fluid and a movable toggle supported by the rigid outer tube and configured to move between a first position and a second position wherein the movable toggle is further configured to apply a radially inward pressure on the resilient inner tube when moved from the first position to the second position.

### BACKGROUND

The present invention relates to hose nozzles. More particularly, the present invention relates to a hose nozzle having a defined and adjustable fluid flow.

Hoses are commonly used for irrigation, gardening, cleaning, and firefighting, amongst other things. Each of the aforementioned uses requires various levels of fluid pressure and possibly, distinctive profiles. Past hoses nozzles have been provided that supply the user with the ability to adjust the fluid pressure while also modifying the fluid profile.

For example, a pistol grip nozzle, that is, one with a tubular body and a handle may be supplied with a rotatable element at a posterior end of the nozzle for which different fluid profiles are available by twisting the element in a clock-wise or counter-clockwise direction. Typically, fluid pressure is controlled by the amount of pressure supplied by the user through the handle.

Barrel type nozzles, on the other hand, typically include a cylindrical body and two open ends. The posterior end is typically configured to connect to the garden hose, while the anterior end is configured to define fluid pressure and fluid profile. In some known configurations, the water profile and flow rate may be defined by rotating a forward cylindrical element into different positions. For example, as shown in FIG. 1, U.S. Pat. No. 3,550,861 (labeled “Prior Art”) describes a nozzle (A) having a rigid tube (D) forming a cylindrical body, a control member (G) having internal threads which engage threads on the rigid tube (D). When a user rotates the control member (G), for example, 360 degrees or more to a closed position, the control member (G) moves longitudinally towards three circumferentially spaced balls (F), which are forced up a cam surface (H) to deform a resilient tubular member (B) in which fluid flows, thus constricting the flow of fluid. A flat circular flange (C) is further provided that projects outwardly from a first end of member (B) to form a right angle (R) at the water entrance. A cup-shaped member is further provided for mating the end of the hose.

Another example of a configuration of this type is described in U.S. Pat. No. 4,930,704, which describes a flow controllable spray nozzle comprising a barrel with a pair of symmetrical, helically-inclined slots on the outside surface and a partition plate with a hole formed therethrough disposed inside the barrel, an internally-threaded control ring with an inside diameter greater than the inside diameter of a housing integrated thereunder, and a plunger secured inside the housing with a threaded nozzle cup screwed on the control ring to define a space therebetween.

However, the configurations of the nozzles described above may have an unsteady fluid flow, and thus, increased turbulence. Increased turbulence may, in turn, lead to a degradation of the fluid stream and decrease the range of possible fluid pressure. Also, in these configurations, it is required that to increase or decease fluid flow, a user must twist the nozzle a number of times, which may be awkward and ergonomically inefficient.

In attempt to alleviate the user from using two hands to rotate the nozzle, U.S. Pat. No. 6,036,117 describes a hose nozzle having a hand grip, an outer sleeve member and an annular beveled collar located in sufficient proximity to the hand grip to allow manual actuation by a user's index finger and thumb. The outer sleeve member and the annular collar may be extended or retracted by rotation. An inner stem has an orifice which allows water to flow out of the inner stem and through the aperture when the outer cylinder is extended. Water flow is controlled by rotating the annular collar to permit water to flow through the tubular body, the inner stem, orifice and out of the aperture of the outer sleeve member.

However, this configuration does not alleviate the problem of turbulent flow, nor is it applicable to a variety of nozzle configurations, particularly a nozzle such as described in U.S. Pat. No. 3,550,861.

To increase the range of fluid pressure, U.S. Pat. No. 6,089,474 describes an apparatus for selectively discharging a stream of liquid has a body adapted for connection to a source of liquid under pressure, a throttle valve assembly for maintaining a constant output flow throughout changes in supply pressure, a smooth bore barrel for providing a deluge stream, a fog tip for providing an aspirated fog spray and a shut off valve.

However, nozzles that rely on throttle valves are typically expensive and prone to malfunction. Also, the aforementioned configurations may be ergonomically inefficient due to the level of rotational sensitivity,

### BRIEF DESCRIPTION

The present disclosure describes a hose nozzle having a controlled fluid flow.

In an embodiment, the invention provides a hose nozzle having a rigid outer tube, an internally threaded cup-shaped member mounted on the first end of the rigid outer tube, a resilient tube member positioned within the rigid outer tube, and a plurality of circumferentially spaced balls supported by a control member, the hose nozzle comprising an arched flange member located at the posterior end of the resilient tube member and operably coupled to the cup-shaped member, wherein the arched flange member comprises a face having a rounded edge defining a fluid entrance of the resilient tube member, the rounded edge configured to reduce turbulent fluid flow.

In another embodiment, the invention provides a hose nozzle having a cam surface extending to an anterior end of the resilient tube member and sloping away from the resilient tube member at an angle of not less than 60 degrees, such that a rotation of the control member of not less than 180 degrees operates to adjust the tube resilient member from an open position to a close position.

In another embodiment, the invention provides a hose nozzle comprising a rigid tube outer tube, a resilient inner tube member disposed within the rigid outer tube and configured to define a flow of fluid, and a movable toggle supported by the rigid outer tube and configured to move between a first position and a second position, wherein the movable toggle is further configured to apply a radially inward pressure on the resilient inner tube when moved from the first position to the second position.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 is side view of a prior art hose nozzle.

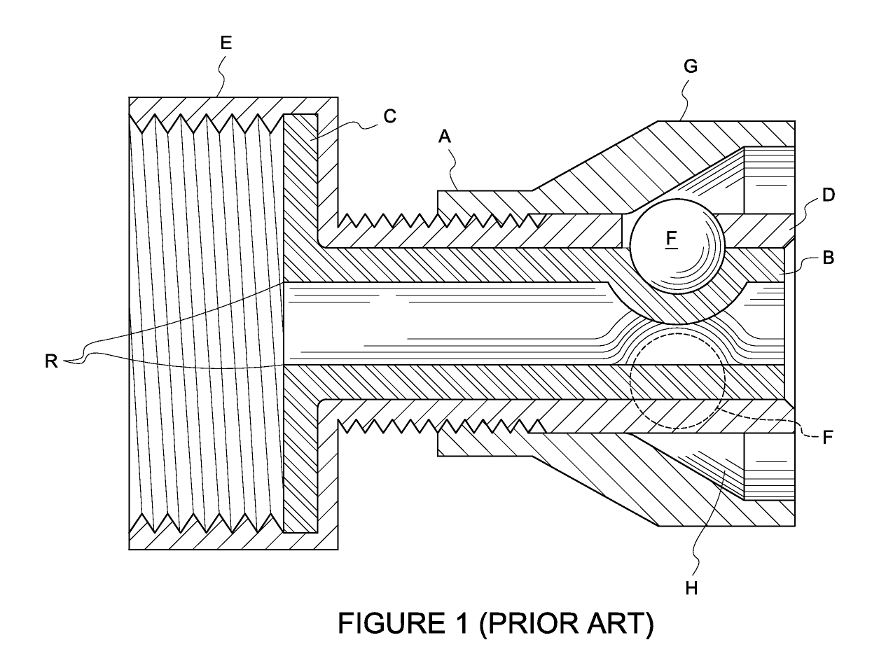

FIG. 2a is perspective view of the tubular member and flanges in accordance with an embodiment of the present invention.

FIG. 2b is another is perspective view of the tubular member and flanges in accordance with another embodiment of the present invention.

FIG. 3 is a perspective view of a hose nozzle in accordance with an embodiment of the present invention.

FIG. 4 is a side view of a hose nozzle in accordance with an embodiment of the present invention.

Like reference characters designate identical or corresponding components and units throughout the several views, which are not to scale unless otherwise indicated.

### DETAILED DESCRIPTION

One embodiment of the present invention provides a barrel-type hose nozzle having a rigid outer tube, an internally threaded cup-shaped member mounted on the first end of the rigid outer tube, a resilient tube member positioned within the rigid outer tube, and a plurality of circumferentially spaced balls supported by a control member. For a general discussion of a hose nozzle of this type, U.S. Pat. No. 3,550,861 is herein incorporated by reference (See col. 1 lines 65-75 and col. 2 lines 1-57). The hose nozzle of the present invention comprises an arched flange member located at the posterior end of the resilient tube member and operably coupled to the cup-shaped member, wherein the arched flange member comprises a face having a rounded edge defining a fluid entrance of the resilient tube member, the rounded edge configured to reduce turbulent fluid flow.

Specific configurations and arrangements of the claimed invention, discussed below with reference to the accompanying drawings, are for illustrative purposes only. Other configurations and arrangements that are within the purview of a skilled artisan can be made, used, or sold without departing from the spirit and scope of the appended claims. For example, while some embodiments of the invention are herein described with reference to hose nozzles for purposes of irrigation, a skilled artisan will recognize that embodiments of the invention can be implemented in other settings such as firefighting and fluidics.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features. As used herein, the term “approximately” may be defined as a given measurement varying as much as 10 percent of the total measurement in any direction. As used herein, the term “turbulent flow” is defined as a flow characterized by recirculation, eddies, and apparent randomness.

One embodiment of the present invention relates to a hose nozzle for decreasing turbulence when a fluid enters the hose nozzle from the hose, thereby, if desired, allowing for an increase in the pressure of the fluid as it leaves the nozzle, greater than otherwise possible. The hose nozzle has an arched flange member located at the posterior end of the resilient tube member and is operably coupled to the cup-shaped member, wherein the arched flange member comprises a face having a rounded edge defining a fluid entrance of the resilient tube member, the rounded edge configured to reduce turbulent fluid flow.

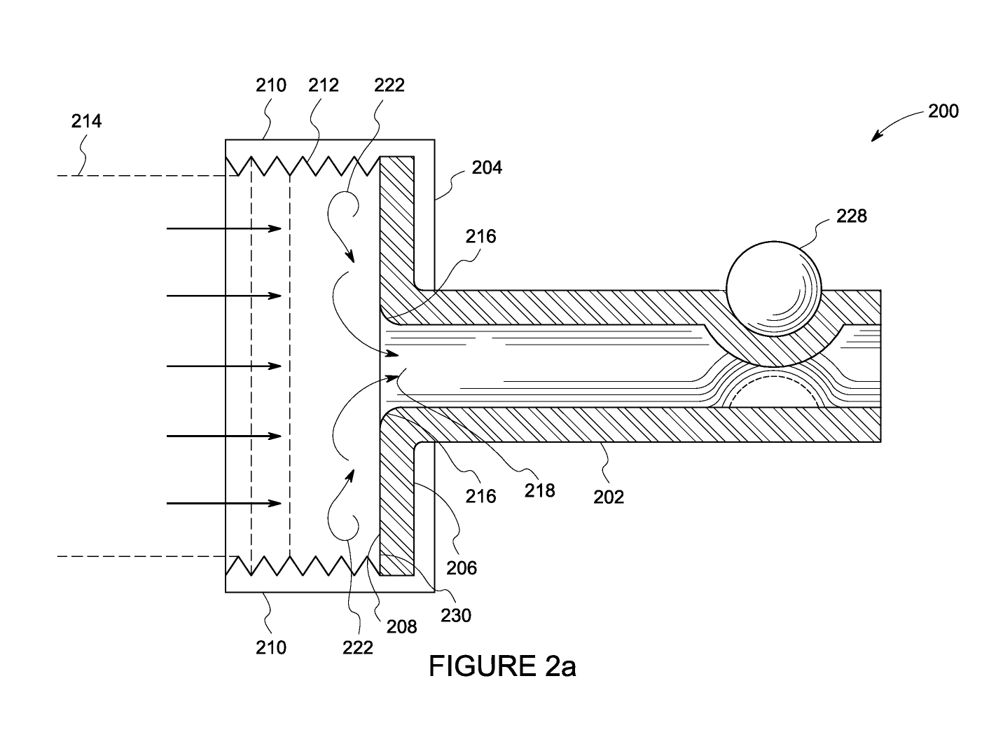

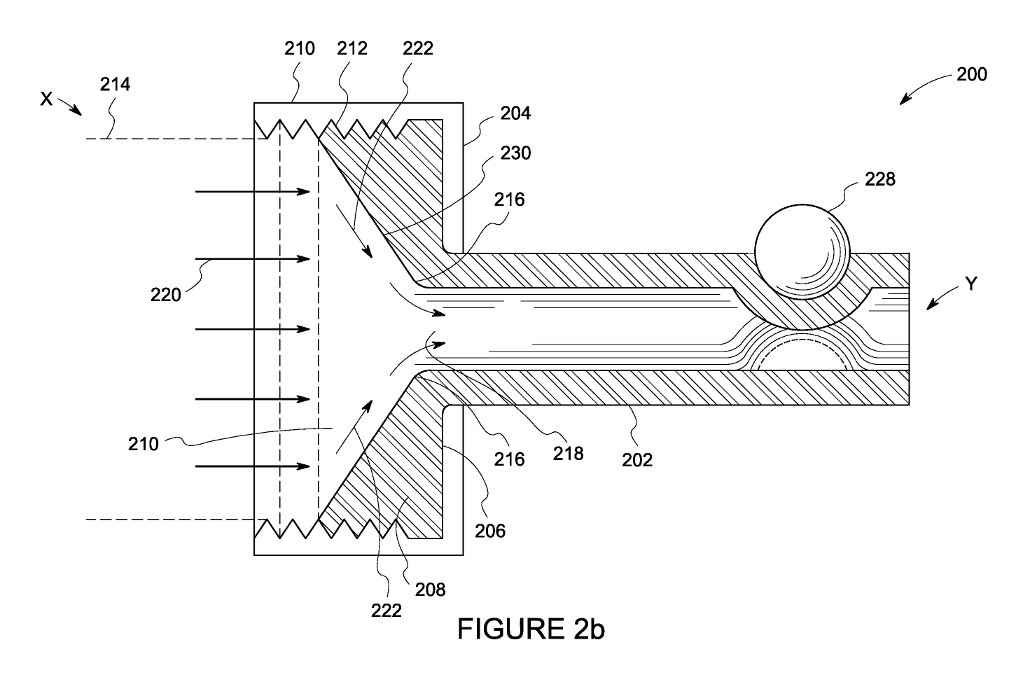

Referring now to FIG. 2a, in an exemplary embodiment of the present invention, a tube member 202 having a flange 208 is shown generally at reference numeral 200. The tube member 202 is an internal component of a barrel type hose nozzle. As shown, the tube member 202 is attached to cap assembly 204 and may comprise a female mating portion 210, which is configured to mate, via opposing threads 212, with the end of a hose 214.

The tube member 202 may comprise, on a posterior end 206, an arched flange member 208 comprising a face 230. The face 230 may have rounded edges 216 defining a fluid entrance 218 in which a fluid, e.g., water, may enter the tube member 202. The fluid flow, demarked by arrows 220, may flow towards the face 230 of flange member 208. In operation, as fluid contacts the face 210, the fluid may be recirculated towards the fluid entrance 218, demarked by circular arrows 222, creating turbulence. However, rounded edges 216 of the flange member 208 are provided to reduce this turbulent flow, allowing the fluid to adhere to the face 210 of the tubular member and enter the tubular member with reduced turbulence. In turn, the fluid may be supplied with increased water pressure as it leaves the nozzle, even when the incoming fluid pressure from the hose remains constant.

Referring now to FIG. 2b, in an exemplary embodiment of the present invention, the flange member 208 may be further provided with decreased slope angle, protruding towards the posterior end (X) of the nozzle. The decreased slope angle (e.g., 60 degrees) is also provided to reduce turbulent flow.

The flange member 208 may be formed from a synthetic polymer or synthetic polymer blend having a Durometer hardness of between approximately 40-60. In fact, the material may be changed with respect to desired fluid profile and function. For example, if a synthetic polymer with a hardness of 40 and 60 is provided, the fluid flow may increase fluid velocity by as much 30 percent. The ability to change the flange insert gives the user the ability to perform multiple tasks which may require varying degrees of fluid flow and also, differing fluid profiles.

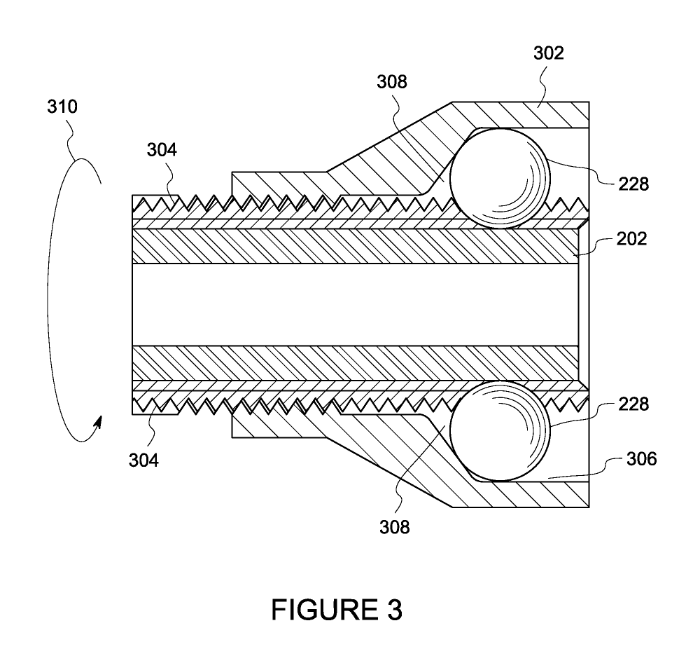

Referring now to FIG. 3, in an exemplary embodiment of the present invention, a control member 302 is shown having mating threads to mate with rigid tube 304 threads. In operation, when the control member 302 is rotated, for example, in the direction of arrow 310, the thread mating allows the control member 302 to move longitudinally towards an anterior portion (Y) of the nozzle 306. The cam surface 308 pushes the balls 228 inwardly to deform the hose member 202 to allow for adjustable fluid pressure and fluid profile. However, past hose nozzles, such as the nozzle described in U.S. Pat. No. 3,550,861 provide a cam surface that requires the user to make multiple turns (e.g., in excess of 1080 degrees) of the control member 302 to adjust the hose from an open position to a closed position. In the present invention, the cam surface 308 is provided with an increased slope (e.g., 60 degrees) such that a user is only require to rotate the control member 180 degrees to adjust the hose from an open position to a closed position.

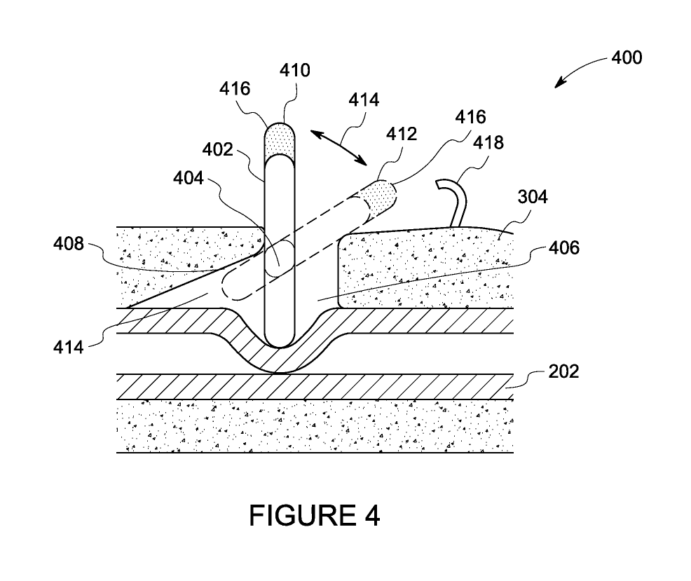

Referring now to FIG. 4, an optional embodiment of the present invention is shown, in which the control member comprises a toggle 402. A side view of the rigid outer tube 304, resilient inner tube 202, and movable toggle 402 in accordance with an embodiment of the present invention is shown generally at 400. During operation of a hose nozzle, a user may prefer to adjust fluid pressure and define fluid profile using a single digit (e.g., thumb) rather than rotating the control member using two digits (e.g., thumb and forefinger). Thus, the present invention provides for, in an optional embodiment, a movable toggle 402 for adjusting the hose 400 from a closed position to an open position.

The movable toggle 402 may be supported by the rigid outer tube 304 and configured to move between a first position 410 and a second position 412, as shown by double headed arrow 414. More particularly, the hose nozzle 400 may comprise a toggle joint 404 which may be pivotally mounted within the rigid outer tube 304. The toggle joint 404 may be positioned adjacently through a bore in the movable toggle 402 and be connected to the rigid outer tube 304 to provide support for the toggle 402. The toggle 402 may further comprise a spring 408 configured to apply a constant pressure on an end of the toggle 402 to provide for a “natural” position, that is, the position that the toggle 402 rests when no pressure is being applied. In an exemplary embodiment of the present invention, the first position 410 corresponds to an OFF position while the second position 412 corresponds to an ON position.

Still referring to FIG. 4, the rigid outer tube 304 may comprise a bore 406 which may comprise an inwardly sloped sidewall 414 such that, when the toggle 402 is in position 412, the inwardly sloped sidewall 414 is configured and dimensioned to impeded the movable toggle at a predetermined position (e.g., approximately 20 degrees). The sidewall may also be dimensioned to impede the toggle 402 when in position 410, but impedes the toggle 402 at a top end rather than a bottom end, such as at position 412.

The toggle 402 may comprise a thumb dial 416 at an outer end of the toggle 402 configured to provide gripping and comfort to the user. In operation, in a configuration in which the OFF position 412 is the natural position, a radially inward pressure is being supplied to the resilient tube member 202 such that fluid is unable to pass therethrough. To adjust the nozzle into an ON position, a user may, using his or her thumb, apply a pressure to the toggle 402 which, in turn, alleviates the radially inward pressure on the resilient inner tube member 202, thus allowing fluid to pass therethrough at a desired pressure and profile, which depends on the amount of pull force applied by the user. A latch 418 is further provided to hold the toggle in a predetermined position (e.g., ON position). The converse, that is, the ON position being the natural position, is also attainable and in the purview of the present invention, and is sustainable by adjusting the position of the spring 408, in an optional embodiment.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

What is claimed is:

1. A hose nozzle having a rigid outer tube, an internally threaded cup-shaped member mounted on the first end of the rigid outer tube, a resilient tube member positioned within the rigid outer tube, and a plurality of circumferentially spaced balls supported by a control member, the hose nozzle comprising:
an arched flange member located at the posterior end of the resilient tube member and operabley coupled to the cup-shaped member, wherein the arched flange member comprises a face having a rounded edge defining a fluid entrance of the resilient tube member, the rounded edge configured to reduce turbulent fluid flow.

2. The hose nozzle of claim 1, further comprising a cam surface extending to an anterior end of the resilient tube member and sloping away from the resilient tube member at an angle of not less than 60 degrees, such that a rotation of the control member of not less than 180 degrees operates to adjust the tube resilient member from an open position to a close position.

3. The hose nozzle of claim 1, wherein the control member further comprises a bore and a trigger disposed radially therethrough.

4. The hose of claim 1, wherein the tubular member if formed from a synthetic polymer.

5. The hose of claim 1, wherein the synthetic polymer has a dimensionless durometer value of approximately 50.

6. A hose nozzle comprising:
a rigid tube outer tube;
a resilient inner tube member disposed within the rigid outer tube and configured to define a flow of fluid; and
a movable toggle supported by the rigid outer tube and configured to move between a first position and a second position;
wherein the movable toggle is further configured to apply a radially inward pressure on the resilient inner tube when moved from the first position to the second position.

7. The hose nozzle of claim 6, further comprising a toggle joint pivotally mounted within the rigid outer tube and positioned adjacently through a bore in the movable toggle.

8. The hose nozzle of claim 6, wherein the movable toggle comprises a thumb dial at an outer end.

9. The hose nozzle of claim 6, wherein the first position corresponds to a FLUID ON position and the second position corresponds to a FLUID OFF position.

10. The hose nozzle of claim 6, wherein the toggle comprises a spring, wherein the spring is configured such that the first or second position is a natural position.

11. The hose nozzle of claim 6, wherein the rigid outer member comprise a bore having a inwardly sloped side wall, the inwardly sloped side wall being dimensioned to impede the movable toggle at a predetermined position.

12. The hose nozzle of claim 6, wherein the rigid outer member further comprises a latch configured to hold the toggle in the second position.

13. The hose nozzle of claim 6, further comprising:
an internally threaded cup-shaped member mounted on the a first end of the rigid outer tube;
an arched flange member located at a posterior end of the resilient tube member and operabley coupled to a cup-shaped member, wherein the arched flange member comprises a face having a rounded edge defining a fluid entrance of the resilient tube member, the rounded edge configured to reduce turbulent fluid flow.

14. The hose of claim 6, wherein the defined an amount of the radially inward pressure corresponds to a force exerted in the thumb dial from a users digit.

15. The hose of claim 6, wherein the slope of the side wall is approximately 20 degrees.
